(19) United States
(12) Patent Application Publication
(10) Pub. No.: US 2005/0157214 A1
(43) Pub. Date: Jul. 21, 2005

(54) Image signal processing device and image signal processing method

(76) Inventors: Tatsuya Takahashi, Ogaki-shi (JP); Tohru Watanabe, Ogaki-shi (JP); Osamu Tabata, Gifu-shi (JP)

Correspondence Address: OSHA LIANG L.L.P., 1221 MCKINNEY STREET, SUITE 2800, HOUSTON, TX, 77010, US

(21) Appl. No.: 10/985,738

(22) Filed: Nov. 10, 2004

(30) Foreign Application Priority Data
Nov. 11, 2003 (JP) 2003-380995

(51) Int. Cl. H04N 5/16

(52) U.S. Cl. 348/691

(57) ABSTRACT

An image signal is processed which include an ineffective image signal period including a vertical optical black signal and an effective image signal period including a horizontal optical black signal and an effective image signal and following the ineffective image signal period, an AGC circuit for amplifying an image signal at an optional gain and a clamp circuit for clamping the reference level of the amplified image signal are included, and the clamp circuit performs clamping at clamp time constants different from each other when clamping the vertical optical black signal and when clamping the horizontal optical black signal. Thereby, an image having a preferable quality is obtained.

### CROSS-REFERENCE TO RELATED APPLICATIONS

The entire disclosure of Japanese Application No. 2003-380995 including specification, claims, drawings and abstract is incorporated herein by reference.

### BACKGROUND OF THE INVENTION

1. Field of the Invention

The present invention relates to an image signal processing apparatus and an image signal processing method for controlling the DC level of an image signal.

2. Description of the Prior Arts

The DC level (Direct Current Level) of an image signal obtained by an image capture device can fluctuate in accordance with the intensity of the light received by the device. Therefore, in the case of a CCD (Charge Coupled Device), alight-shielded pixel region, that is, an optical black (OPB) region is formed at the marginal portion of the effective pixel region of an image capture section and processing is performed which clamps a reference level showing the black level of an image in accordance with an optical black signal (OPB signal) obtained corresponding to the OPB region. Moreover, in the case of an output of an AGC (Auto Gain Control) circuit set to the rear stage of the pixel region, the black level of an image signal, that is, a DC level, can fluctuate in accordance with the gain of the output. Therefore, a clamp circuit for controlling a DC level is set to the rear stage of the AGC circuit.

As shown in FIG. 5, a conventional image signal processing apparatus is comprised of an analog signal processing circuit 2, analog/digital (A/D) conversion circuit 4, a digital signal processing circuit 6, and a gain setting circuit 8. The analog signal processing circuit 2 includes the AGC circuit 20, a clamp circuit 22, and a digital/analog (D/A) conversion circuit 24. The AGC circuit 20 amplifies an image signal sent from a CCD solid image capture device by a gain setting circuit 8. The amplified output is clamped by the clamp circuit 22. A signal output from the analog signal processing circuit 2 is converted from an analog signal into a digital signal by the A/D conversion circuit 4 and input to the digital signal processing circuit 6. The digital signal processing circuit 6 includes an integration circuit 30 and a determination circuit 32. The integration circuit 30 integrates image signals for one screen. The determination circuit 32 compares the integration result by the integration circuit 30 with a predetermined reference value and outputs the comparison result to the gain setting circuit 8. The gain setting circuit 8 amplifies a gain G in accordance with the comparison result by the determination circuit 32. Thus, control is performed so that the average level of image signals for each screen from the CCD solid image capture device is kept in a predetermined dynamic range.

The clamp circuit 22 connects a signal line to a reference voltage source in an OPB signal period synchronously with a horizontal sync signal HD accompanying an image signal. As a result, the DC level of the image signal is clamped at a predetermined potential and a black level is set to a constant level. The time constant of the clamp circuit 22, that is, the clamp time constant, is determined by a clamp pulse CL generated by a clam pulse generation circuit 28. Specifically, the clamp pulse generation circuit 28 adjusts the current supply quantity to be supplied from the reference voltage source to a signal line in each clamp operation. For example, the clamp time constant decreases as the current supply quantity at one time of clamp operation increases and the DC level quickly converges to the voltage of the reference power supply.

However, external noise may be superimposed on the OPB signal. When clamping the DC level in accordance with the OPB signal on which a noise component is superimposed, the clamped DC level is influenced by the noise component. That is, the clamped DC level fluctuates every horizontal line of an image signal. As a result, noise extending in the horizontal line direction may appear in a reproduced image.

The extent to which the DC level follows the noise component when clamped depends on the clamp time constant. Specifically, when decreasing the clamp time constant, the clamped DC level easily follows the fluctuation of the noise component. Therefore, to decrease transverse noise extending in the horizontal line direction, it is preferable to set the clamp time constant to a large value and perform the clamp processing of the DC level along more horizontal lines. However, from the viewpoint of keeping the black level of an image signal constant, it is preferable to set the clamp time constant to a small value and quickly perform the clamp processing of the DC level. The clamp time constant is set to a constant value so that a more preferable reproduced image can be obtained by considering these conditions.

The extent to which the clamped DC level follows the fluctuation of the noise component also depends on the magnitude of the noise component. The magnitude of the noise component included in an image signal output from the AGC circuit 20 directly depends on the gain of the AGC circuit 20.

In the case of a conventional image signal processing apparatus, when the gain of the AGC circuit 20 is changed, fluctuation also occurs in the DC level of an amplified image signal. Therefore, it is necessary to clamp the DC level of the image signal again. To eliminate the influence of the image on the DC level due to the gain change, that is, the influence on the black level, it is preferable to set the clamp time constant to a small value and more quickly clamp the DC level of an image to the reference level. However, as described above, when decreasing the clamp time constant, the clamped DC level easily follows the fluctuation of the noise component. Therefore, transverse noise extending in the horizontal line direction easily occur. Particularly, when increasing gain, the amplitude of the noise component superimposed on an image signal is increased and the clamped DC level becomes unstable. As a result, there is a problem that transverse noise along the horizontal line occurs easily.

### SUMMARY OF THE INVENTION

The present invention is an image signal processing apparatus for processing an image signal including an ineffective image signal period including a vertical optical black signal and an effective image signal period including a horizontal optical black signal and an effective image signal and following the ineffective image signal period, which comprises an amplifying circuit for amplifying the image signal at an optional gain and a clamp circuit for clamping the reference level of the amplified image signal and has a feature that the clamp circuit clamps the vertical optical black signal and the horizontal optical black signal at clamp time constants that are different from each other.

Another aspect of the present invention is an image processing method for processing an image signal including an ineffective image signal period including a vertical optical black signal, an effective image signal period including a horizontal optical black signal and an effective image signal and following the ineffective image signal period, comprising a first step of amplifying the image signal at an optional gain and a second step of clamping the reference level of the image signal amplified in the first step, in which image signals such as the vertical optical black signal and the horizontal optical black signal are clamped at clamp time constants that are different from each other.

### BRIEF DESCRIPTION OF THE DRAWINGS

FIG. 1 is a block diagram showing a configuration of an image signal processing apparatus of an embodiment of the present invention;

FIG. 2 is an illustration showing a timing chart in an image signal processing method of an embodiment of the present invention;

FIG. 3 is an illustration showing a configuration of an image capture device including an optical black region and an effective pixel region;

FIG. 4 is a circuit block diagram of a clamp circuit for switching clamp capacities by changing supply currents; and

FIG. 5 is a block diagram showing a configuration of an image signal processing apparatus of the background art.

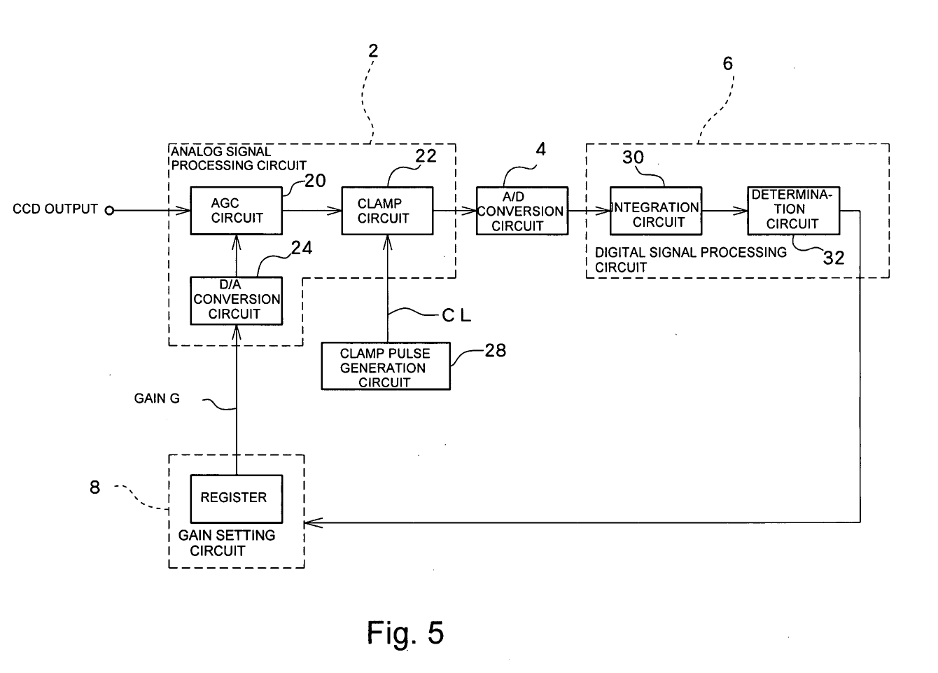

### DESCRIPTION OF THE PREFERRED EMBODIMENTS

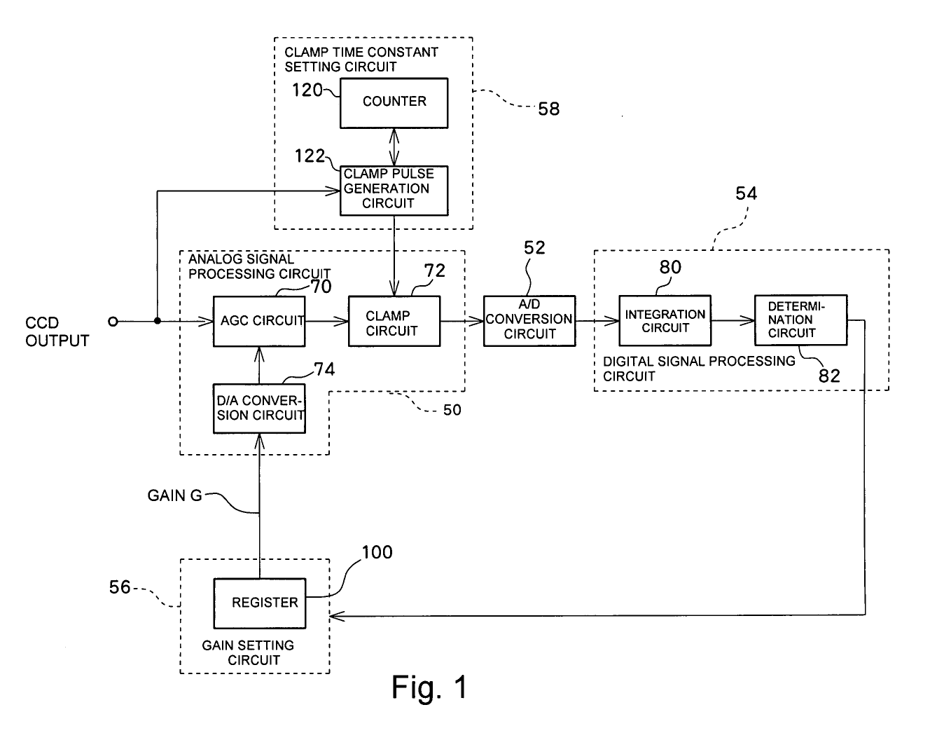

Image signal processing apparatuses of an embodiment of the present invention are respectively comprised of an analog signal processing circuit 50, analog/digital (A/D) conversion circuit 52, digital signal processing circuit 54, gain setting circuit 56, and clamp time constant setting circuit 58 as shown in FIG. 1.

The analog signal processing circuit 50 has an AGC circuit 70, clamp circuit 72, and digital/analog (D/A) conversion circuit 74. The AGC circuit 70 receives an image signal from an image capture device such as a CCD solid image capture device and amplifies the image signal in accordance with the gain G supplied from the gain setting circuit 56.

The clamp circuit 72 is a circuit for clamping the DC level of an image signal amplified by the AGC circuit 70. Specifically, the clamp circuit 72 is comprised of a switch to be connected to a reference voltage source and an image signal line. The time constant when clamping the DC level of an image signal by the clamp circuit 72, that is, the clamp time constant, is set by the clamp time constant setting circuit 58.

A clamp time constant can changed by controlling the time width for turning on a switch in accordance with the pulse width of a clamp pulse. When the time for turning on the switch becomes long, a potential corresponding to the black level of an image signal approaches the voltage of the reference voltage source quickly (that is, in a shorter clamp time). That is, as the pulse width of the clamp pulse is increased, the DC level of the image signal is more quickly clamped. In other words, as the pulse width of the clamp pulse is increased, the clamp time constant is set to a smaller value.

Moreover, it is possible to change the clamp time constant by controlling the current supply capacity supplied from the reference voltage source. Specifically, by changing the current supply capacity of the reference voltage source in accordance with the pulse width of the clamp pulse, the current quantity supplied to the image signal line from the reference voltage source is changed in accordance with one-time clamp operation. As the time for turning on the switch becomes longer, the potential corresponding to the black level of the image signal approaches the voltage of the reference voltage source more quickly (that is, in a shorter clamp time). That is, as the current supply quantity supplied from the reference voltage source is increased, the DC level is more quickly clamped. In other words, as the current supply capacity supplied from the reference voltage source is increased, the clamp time constant is set to a smaller value.

An image signal whose DC level is adjusted by the clamp circuit 72 is input to the A/D conversion circuit 52. The A/D conversion circuit 52 converts an image signal into a digital signal and outputs the digital signal. The digital image signal is output to the digital signal processing circuit 54.

The digital signal processing circuit 54 can be constituted so as to receive a digital image signal and perform various image processing in addition to generation processing of the brightness signal and color difference signal of the digital image signal. Among these image processings, FIG. 1 shows an integration circuit 80 and determination circuit 82 relating to the feedback control of the gain of this image signal processing apparatus. For example, the integral value of image signals for one screen is obtained at the integration circuit 80. The determination circuit 82 compares the integral value obtained by the integration circuit 80 with a predetermined target range and performs the determination for increasing the gain when the integral value is lower than the target range, the determination for decreasing the gain when the integral value is higher than the target value, and the determination for keeping the gain in the present state when the integral value is kept in the target range. The determination result generated by the determination circuit 82 is transmitted to the gain setting circuit 56.

In this connection, the integral value obtained by the integration circuit 80 can be used for auto iris control as an example of the above various signal processings.

The gain setting circuit 56 receives the determination result to set the gain G of the AGC circuit 70. The gain setting circuit 56 outputs the gain G to the D/A conversion circuit 74 synchronously with the vertical sync signal VD accompanied by an image signal. Because the vertical sync signal VD is a signal showing changeover timing for image signals for one screen, the gain G of the AGC circuit 70 is updated every image signals for one screen.

The gain setting circuit 56 is provided with a register 100. A plurality of types of gain values for the AGC circuit 70 are previously stored in the register 100 and any one of the gain values is selected and output in accordance with a received determination result. For example, the gain setting circuit 56 stores the address of the register 100 in which the last-selected gain value is stored, when the determination result is a determination for increasing the gain G, specifies the address for storing a gain value higher than the gain value stored in the stored address, and outputs the gain value stored at the address. When the determination result is a determination for decreasing the gain G, the gain setting circuit 56 specifies the address for storing a gain value lower than the gain value stored in the stored address, and outputs the gain value stored at the address. Moreover, when the determination result is a determination for keeping the present gain G, the gain value stored at the stored address is read out and output or the present gain value is kept and output without performing a read operation.

The gain G is output from the gain setting circuit 56 as a digital value. The D/A conversion circuit 74 receives the gain G, converts the value of the gain G into an analog value, and outputs the analog value to the AGC circuit 70. The AGC circuit 70 amplifies an image signal as described above in accordance with the gain G converted into the analog value.

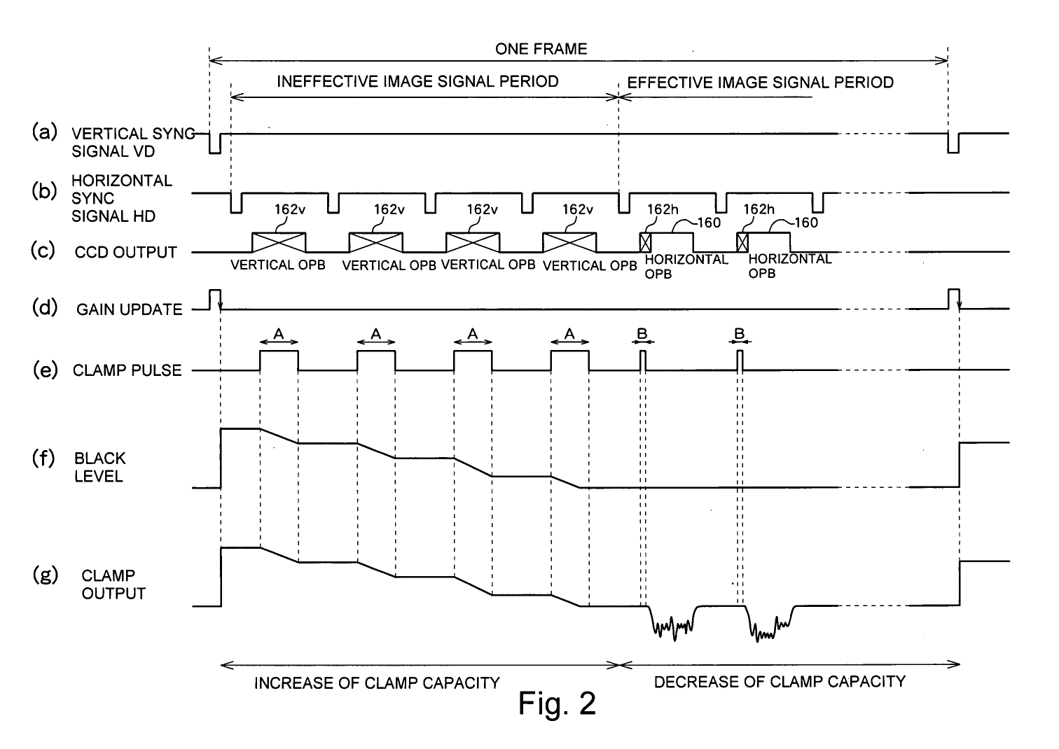

The clamp time constant setting circuit 58 is comprised of a counter 120 and a clamp pulse generation circuit 122. The clamp pulse generation circuit 122 outputs a clamp pulse to the clamp circuit 72 by using the counter 120. FIG. 2 shows a timing chart when a clamp pulse is generated by the clamp time constant setting circuit 58 and the reference level of an image signal is clamped by the clamp circuit 72.

An image signal is continuously constituted every screen. As shown in FIG. 2(a), image signals for one screen are constituted by including a plurality of image signals for one horizontal line delimited by a horizontal sync signal HD. A vertical sync signal VD is included at the head portion of image signals for one screen to show the partition between screens of the image signals. An image is reproduced by horizontally scanning image signals for one horizontal line while making screens synchronize with each vertical sync signal VD and thereby switching screens and making screens synchronize with each horizontal sync signal HD.

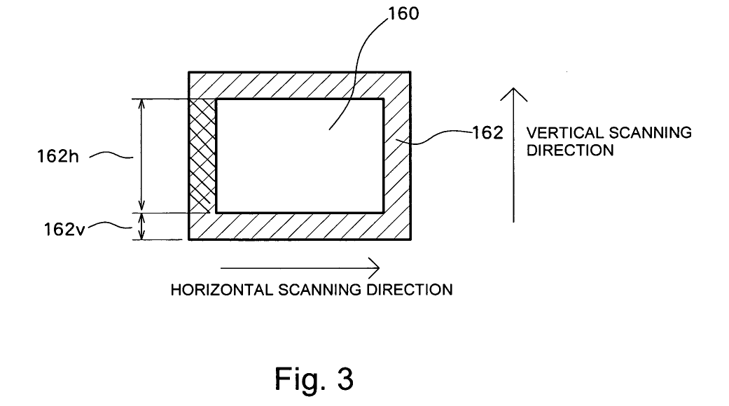

As shown in FIG. 3, the image capture device is provided with an effective pixel region 160 in which photoelectric conversion elements are arranged so that external light can be received and an optical black (OPB) region 162 in which photoelectric conversion elements, which are light-shielded so that external light cannot be received, are arranged. Therefore, in an output signal from the image capture device, an ineffective image signal period corresponding to vertical optical black signals for a plurality of horizontal lines obtained corresponding to a vertical optical black region 162v which is a part of the OPB region 162v appears by following the vertical sync signal VD as shown in FIGS. 2(a) to 2(c). Each of the vertical optical black signals are delimited by the horizontal sync signal HD for every horizontal line. Then, a horizontal optical signal obtained corresponding to a horizontal optical black region 162h which is a part of the OPB region 162 and an effective image signal obtained corresponding to the effective pixel region 160 appear, and an effective image signal period corresponding to image signals for a plurality of horizontal lines continues. Horizontal optical black signals and effective image signals are delimited by the horizontal sync signal HD for every horizontal line. OPB signals obtained corresponding to the vertical optical black region 162v and horizontal optical black region 162h are used to decide the DC level of an image signal.

As described above, the gain setting circuit 56 outputs the gain G synchronously with the vertical sync signal VD following an image signal as shown in FIG. 2(d). The AGC circuit 70 receives the gain G and updates the gain to amplify the image signal. As a result, as shown in FIG. 2(f), the DC level (black level) of an image signal is deviated from the reference level.

When the clamp pulse generation circuit 122 receives the vertical sync signal VD of an image signal, it resets the value of the counter 120 to the number of horizontal lines in an ineffective image signal period. Then, whenever receiving the horizontal sync signal HD of the image signal, the circuit 122 reduces the value of the counter 120 by 1, and then outputs a clamp pulse to the clamp circuit 72. In this case, when the value of the counter 120 is 0 or more, the circuit 122 outputs a clamp pulse having a pulse width A to a vertical optical black signal as shown in FIG. 2(c). However, when the value of the counter 120 is smaller than 0, the circuit 122 outputs a clamp pulse having a pulse width B smaller than the pulse width A to a horizontal optical black signal. That is, after receiving the vertical sync signal VD, a clamp pulse is output which has a pulse width larger by the number of horizontal lines included in an ineffective image signal period appearing at the head of an image signal, and then a clamp pulse having a smaller pulse width is output until the next vertical sync signal VD is received.

In the case of the example of the image signal in FIG. 2, vertical optical black signals for four horizontal lines are transmitted in an ineffective sync signal period. When the clamp pulse generation circuit 122 receives the vertical sync signal VD, it sets the value of the counter 120 to the number of horizontal lines of the vertical optical black region 162v, that is, 4. Then, when receiving the horizontal sync signal HD, the circuit 122 sets the value of the counter 120 to 3 by reducing the value of the counter 120 by 1. Because the value of the counter 120 is 0 or more, the circuit 122 outputs a clamp pulse having the pulse width A. Similarly, the circuit 122 reduces the value of the counter 120 by 2, 1, and 0 whenever receiving the horizontal sync signal HD and outputs a clamp pulse having the pulse width A as long as the value of the counter 120 is 0 or more. Moreover, when receiving the horizontal sync signal HD, the value of the counter 120 is reduced up to −1 and becomes smaller than 0. Thereafter, the circuit 122 outputs a clamp pulse having the pulse width B.

The clamp circuit 72 receives a clamp pulse from the clamp pulse generation circuit 122 to clamp the DC level of an image signal while changing the pulse width of the clamp pulse and a clamp time constant described as above. In this case, the width of the clamp pulse is set to a large value and the clamp time constant is set to a small value in an ineffective image signal period. Therefore, as shown in FIG. 2(f), the DC level of an image signal is made to quickly approach the reference level. However, in an effective image signal period, the pulse width of a clamp pulse is set to a small value and the clamp time constant is set to a large value. Therefore, as shown in FIG. 2(f), the clamp of the DC level of an image signal does not greatly fluctuate. That is, the clamp time constant when clamping a vertical optical black signal is set to a value smaller than the clamp time constant when clamping a horizontal optical black signal.

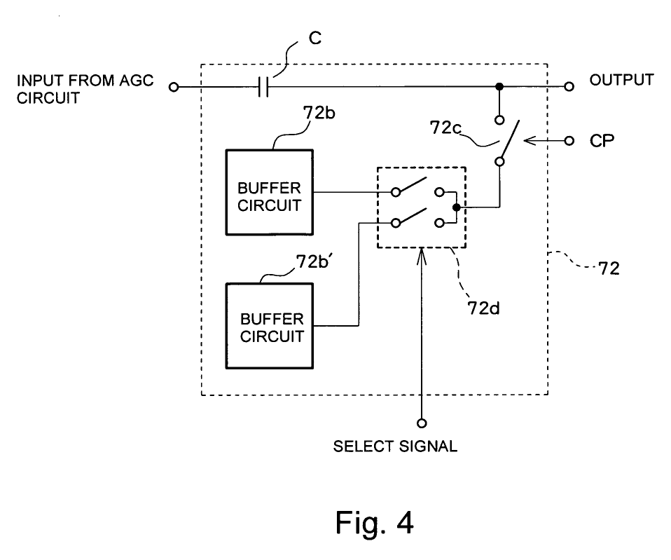

FIG. 4 is a circuit block diagram showing another configuration of the clamp circuit. The clamp circuit 72 is constituted so as to clamp a signal input from the AGC circuit 70, which has a switching device 72c, two buffer circuits 72b and 72b′ arranged in parallel, and a selector 72d for selecting outputs of these two buffer circuits 72b and 72b′ and connecting them to the switching device 72c. In this configuration, when the supply current of the buffer circuit 72b is larger than that of the buffer circuit 72b′, the selector 72d selects the buffer circuit 72b in the above ineffective image signal period and the buffer circuit 72b′ on normal operation in the effective image signal period. For example, it is possible to use a signal from the clamp pulse generation circuit 122 as a select signal for switching and controlling the selector 72d. In this case, the clamp pulse generation circuit 122 outputs an L-level pulse as a select signal when the value of the counter 120 is 0 or more and an H-level pulse as a select signal when the value of the counter 120 is smaller than 0. The selector 72d is constituted so as to select the buffer circuit 72b as a select signal while an L-level pulse is input and the buffer circuit 72b′ while an H-level pulse is input. Moreover, the clamp pulse generation circuit 122 raises a control signal CP only for a predetermined time whenever the horizontal sync signal HD is input and closes the switching device 72c. Therefore, the current to be supplied to a capacitor C increases in an ineffective image signal period and the DC level of an image signal is made to quickly approach the reference level. However, in an effective image signal period, the current to be supplied to the capacitor C decreases and the clamp of the DC level of the image signal does not greatly fluctuate.

Moreover, in the case of the configuration in FIG. 4, when raising a clamp capacity compared to the case of the normal operation in the ineffective image signal period as above, it is possible to raise the clamp capacity by making outputs of both the buffer circuits 72b and 72b′ effective by the selector 72d. That is, by selectively combining effective buffer circuits among a plurality of buffer circuits, a clamp capacity is changed. It is allowed for the current supply capacities of the two buffer circuits 72b and 72b′ to be set equally or mutually differently from each other.

As described above, according to this embodiment of the invention, it is possible to quickly clamp the DC level of an image signal shifted from the reference level in accordance with a change of amplification gains at the reference level in an OPB signal period not relating to reproduction of an actual image. That is, it is possible to obtain an image having a preferable image quality to which a black level is properly set. Moreover, after the DC level of the image signal is once clamped at the reference level, it does not easily follow the fluctuation of a noise component. Therefore, it is possible to restrain transverse noise extending in the horizontal line direction from occurring. Particularly, it is possible to effectively restrain transverse noise along the horizontal line, which is easily generated when increasing a gain in accordance with a gain change.

Because a shift of the DC level of an image signal from the reference level following gain adjustment depends on a gain value, it is also preferable to change the width of a clamp pulse in an OPB signal period in accordance with a gain value. For example, as a gain is set to a larger value, it is preferable to further increase a pulse width in the OPB signal period and further decrease a clamp time constant.

The present invention is not restricted to the above described embodiments but various modifications can be applied to the present invention as long as they do not deviate from the gist of the present invention.

1. An image signal processing apparatus for processing an image signal including an ineffective image signal period including a vertical optical black signal and an effective image signal period including a horizontal optical black signal and an effective image signal and following the ineffective image signal period, comprising:
an amplifying circuit for amplifying the image signal at an optional gain; and
a clamp circuit for clamping a reference level of the amplified image signal; wherein
the clamp circuit clamps the vertical optical black signal and the horizontal optical black signal at clamp time constants different from each other.

2. The image processing apparatus according to claim 1, wherein
the clamp circuit has the clamp time constant when clamping the vertical optical black signal smaller than the clamp time constant when clamping the horizontal optical black signal.

3. The image signal processing apparatus according to claim 1, comprising
a clamp pulse generation circuit which outputs clamp pulses having pulse widths different from each other at the time when the vertical optical black signal is input to the clamp circuit or the time when the horizontal optical black signal is input to the clamp circuit synchronously with the timing at which the vertical optical black signal or the horizontal optical black signal are input to the clamp circuit,
wherein the clamp time constant is variably set in response to the clamp pulse output from the clamp pulse generation circuit in the clamp circuit.

4. The image signal processing apparatus according to claim 2, comprising
a clamp pulse generation circuit which outputs clamp pulses having pulse widths different from each other at the time when the vertical optical black signal is input to the clamp circuit or the time when the horizontal optical black signal is input to the clamp circuit synchronously with the timing at which the vertical optical black signal or the horizontal optical black signal are input to the clamp circuit,
wherein the clamp time constant is variably set in response to the clamp pulse output from the clamp pulse generation circuit in the clamp circuit.

5. The image signal processing circuit according to claim 1, wherein
the clamp circuit includes a plurality of buffer circuits for respectively outputting a predetermined supply current and a selector for selecting any one of the buffer circuits, and
the buffer circuits are selectively made effective through the selector and the clamp time constant is changed and controlled.

6. The image signal processing apparatus according to claim 2, wherein
the clamp circuit includes a plurality of buffer circuits for respectively outputting a predetermined supply current and a selector for selecting any one of the buffer circuits, and
the buffer circuits are selectively made effective through the selector and the clamp time constant is changed and controlled.

7. An image signal processing method for processing an image signal including an ineffective image signal period including a vertical optical black signal and an effective image signal period including a horizontal optical black signal and an effective image signal and following the ineffective image signal period, comprising:
a first step of amplifying the image signal at an optional gain; and
a second step of clamping a reference level of the image signal amplified in the first step; wherein
the second step clamps image signals at clamp time constants different from each other when clamping the vertical optical black signal and when clamping the horizontal optical black signal.

8. The image signal processing method according to claim 7, wherein
in the second step, the clamp time constant when clamping the vertical optical black signal is smaller than the clamp time constant when clamping the horizontal optical black signal.
